(19) United States
(12) Patent Application Publication
(10) Pub. No.: US 2026/0210515 A1
(43) Pub. Date: Jul. 23, 2026

(54) LIGHTING MODULE FOR A MOTOR VEHICLE

(71) Applicant: VALEO VISION, Bobigny (FR)

(72) Inventor: Yves GROMFELD, Bobigny (FR)

(73) Assignee: VALEO VISION, Bobigny (FR)

(21) Appl. No.: 19/141,391

(22) PCT Filed: Dec. 20, 2023
(86) PCT No.: PCT/EP2023/086868

§ 371 Date: Jun. 20, 2025

(30) Foreign Application Priority Data
Dec. 22, 2022 (FR) FR2214355

(51) Int. Cl. F21S 41/663; F21S 41/143; F21S 41/147; F21S 41/151; F21S 41/27; F21S 41/275; F21S 41/365; F21W 102/13

(52) U.S. Cl. CPC F21S 41/663; F21S 41/143; F21S 41/147; F21S 41/151; F21S 41/27; F21S 41/275; F21S 41/365; F21W 2102/13

(57) ABSTRACT

The invention relates to a lighting module. The lighting module includes light sources and a primary lens including two input diopters, an output diopter and two reflective surfaces. The first and second input diopters are respectively configured to receive light rays from the first light sources before they reach the output diopter and to receive light rays from the second light sources before transmitting them to the first reflective surface. The first and second reflective surfaces are respectively configured to reflect, towards the second reflective surface, light rays from the second light sources and to reflect, towards the output diopter, the light rays from the second light sources after their reflection on the first reflective surface. The portions of the first input diopter that are inclined differently are joined by a junction line.

### TECHNICAL FIELD

The present invention relates to the field of lighting, this including signaling, and to the field of members, notably optical members, that contribute thereto. It is particularly advantageously applicable to the field of automotive vehicles. It notably relates to a lighting module.

### BACKGROUND OF THE INVENTION

In the automotive sector, modules capable of emitting light beams, also referred to as lighting and/or signaling functions, are known.

These modules have to meet the applicable regulations, which differ according to the country concerned, by emitting light specifically in certain zones so as to exclude zones that should remain dark, and homogeneously so as to not leave dark zones in the zone that should be lit. One of the constraints that manufacturers also face is the reduction of the size of the module, in order to obtain a module that is the most easily usable.

In order to best achieve these different objectives, a technical solution has been proposed in document FR3077362 A1. This solution is based on the development of a headlamp provided with three beams, so as to form a low beam associated with a complementary high beam making it possible to obtain a desired light distribution. The particular feature of this solution lies in the fact that the near-field beam of a low beam passes through a waveguide in which it undergoes several internal reflections to direct the light beam to the desired positions.

Nevertheless, this type of solution has drawbacks and notably the fact that it does not enable compactness and safety due to the attributes of the sufficiently lit zones.

An object of the present invention is therefore to propose a module that makes it possible to overcome all or some the cited drawbacks.

The other objects, features and advantages of the present invention will be-come apparent upon studying the following description and the accompanying drawings. It will be understood that other advantages may be incorporated.

### SUMMARY OF THE INVENTION

To achieve this objective, according to one embodiment, what is provided is a lighting module comprising:
a first row of first light sources comprising light sources aligned in a first direction,
a set of second light sources,
an optical axis, a first plane being defined so as to contain the first direction and be perpendicular to the optical axis,
a primary lens comprising a first entrance dioptric interface and an exit dioptric interface, the first entrance dioptric interface being configured to receive light rays coming from the first light sources of the first row, the exit dioptric interface being configured to transmit light rays coming from the first light sources of the first row and received by the first entrance dioptric interface,
the primary lens further comprising:
a second entrance dioptric interface, a first reflective surface and a second reflective surface, the second entrance dioptric interface being configured to receive light rays coming from the second light sources of the set and to transmit them to the first reflective surface, the first reflective surface being configured to reflect light rays coming from the second light sources of the set toward the second reflective surface,
characterized in that the second reflective surface is configured to reflect the light rays coming from the second light sources of the set toward the exit dioptric interface after their reflection on the first reflective surface, and
in that the first entrance dioptric interface comprises a first portion and a second portion joined by a junction line, the first portion and the second portion being inclined differently with respect to the optical axis.

It should be apparent that the two portions of the first entrance dioptric interface generate, due to their different inclination, a different refraction at the entry to the lens, thus inducing a greater diversity of direction of the light rays coming from the first row, thus promoting the homogeneity of illumination of the zone corresponding to its rays in the final projected beam.

Thus, the fact that the rays coming from the first light sources of the first row can partially pass through the first portion of the first entrance dioptric interface and partially pass through the second portion of the first entrance dioptric interface (which is inclined differently with respect to the optical axis than the second reflective surface) makes it possible to create, as can be seen in FIG. 4, a different lighting configuration according to the surface through which the rays in question pass. More specifically, in FIG. 4, it is possible to see an upper zone having a sharp upper cutoff toward the top, whereas the lower zone in this same figure has a wider and less sharply defined spread (the lighting in the lower zone can be called “blur” as a result of its spread and deformed shape), the upper zone corresponding to the rays that have passed through the second portion of the first entrance dioptric interface, whereas the lower zone corresponds to the rays that have passed through the first portion of the first entrance dioptric interface.

Furthermore, the positioning of the first reflective surface and of the second reflective surface makes it possible to create a lighting module in which the first light sources and the second light sources share the same exit dioptric interface, this leading to a reduction in the size of the lighting module.

According to an advantageous embodiment, the first portion forms part of the second reflective surface. In this case, the corresponding part of the second reflective surface has a dual function: on the one hand, it realizes a total internal reflection of the rays coming from the second sources; on the other hand, it ensures the entry of certain rays of the second row with a particular refraction at this level due to its inclination.

Thus, given that the first portion forms part of the second reflective surface, the second reflective surface is joined to the first entrance dioptric interface and specifically to the second portion. Consequently, as seen in FIG. 4, the zone lit by the light rays coming from the first light sources that have passed through the first portion will be located in a zone that is also partially lit by the light rays coming from the second light sources. Specifically, the rays coming from the second light sources intercept the second reflective surface by reflection before reaching the exit dioptric interface, whereas the light rays coming from the first light sources intercept the first portion by refraction, thus leading all of these light rays to be directed (after they have passed through the projecting lens) toward a zone positioned below the zone toward which the rays coming from the first light sources and having passed through the second portion are directed after they have passed through the projecting lens. The lower zone in FIG. 4 constituting what has been called “blur” will therefore make it possible to create a transition zone between the beams coming from the second light sources and those coming from the first light sources, in order to create a homogeneous brightness (in the overall zone concerned) that does not have dark zones.

According to another advantageous embodiment, the first row of first light sources is positioned in a direction transverse to the first direction such that between 30% and 50% of the light rays coming from the first row of first light sources are refracted by the first portion.

This lighting module therefore makes it possible, due to the position of the first light sources with respect to the junction line, to obtain a desired height spread of the beam coming from the first light sources, which may notably be a cutoff-containing beam of a low beam.

### BRIEF DESCRIPTION OF THE DRAWINGS

The aims, objects, and the features and advantages of the invention will be-come more clearly apparent from the detailed description of one embodiment of the invention, which embodiment is illustrated by the following accompanying drawings, in which:

FIG. 1 shows a view in section (at the optical axis) of the lighting module according to the invention, where the paths of the light rays can be seen.

FIG. 2 shows an enlarged view of a zone in FIG. 1 notably comprising the first, the second, the third and the fourth row of first light sources, the first entrance dioptric interface and the second reflective surface, where the paths of the light rays can be seen.

FIG. 3 shows the first, the second, the third and the fourth row of first light sources and notably the positioning of the junction line with respect to the first row of first light sources.

FIG. 4 shows the isocandela curves of the luminous intensity coming from a cutoff-containing beam for a low beam, according to the invention, where the configuration of the bottom zone is due to light rays coming from the first light sources being transmitted through the first portion.

The drawings are provided by way of example and do not limit the invention. They are schematic conceptual representations intended to facilitate under-standing of the invention and are not necessarily drawn to the scale of practical applications.

### DETAILED DESCRIPTION OF THE INVENTION

Before starting a detailed review of embodiments of the invention, optional features that may optionally be used in combination or alternatively will be described below:

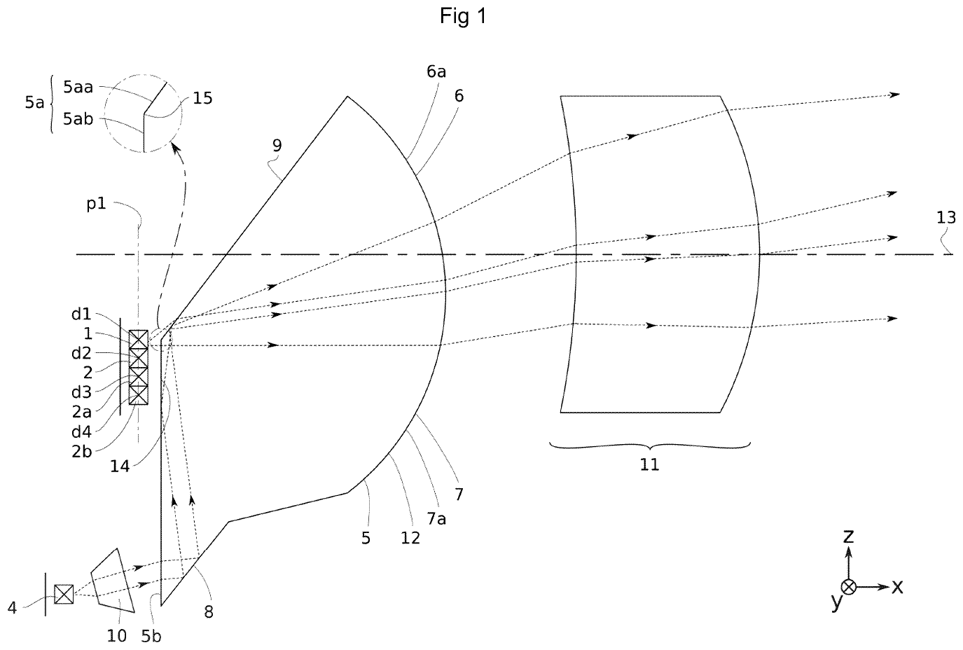

According to one example, as seen in FIG. 1,the first portion 5aa is positioned at the upper end of the first entrance dioptric interface 5a, the first portion 5aa extending from the junction line 15 toward the exit dioptric interface 12.

This configuration makes it possible to form a primary lens 5 comprising in particular in the upper part a set of surfaces that are joined to one another, in order to prevent light rays from exiting the lighting module without contributing to the lighting function.

According to one example, the second reflective surface 9 has a concave profile so as to direct light rays coming from the set 4 of second light sources toward the exit dioptric interface 12.

Thus, in this way, the light rays coming from the set 4 of second light sources contribute to the lighting function as desired and are not excluded therefrom.

According to one example, the second reflective surface 9 forms an angle of between 115° and 155° with the second portion 5ab of the first entrance dioptric interface 5a.

This configuration makes it possible to obtain different lighting configurations depending on whether lighting oriented more toward the top or the bottom is desired.

According to one example, the junction line 15 projects on the first row 1 of first light sources in a direction parallel to the optical axis 13 so as to divide the first row 1 of first light sources into an upper part and a lower part, the lower part being between 1% and 20% greater than the upper part.

This configuration makes it possible to adjust the positioning of the first light sources of the first row 1 with respect to the junction line, in order to better control the height of the cutoff of the beam formed by the first light sources. Thus, for each first light source, a luminous segment is formed by the superposition of the light emitted by the upper portion and the lower portion of the light source.

According to one example, the lighting module comprises a third reflective surface 14, the third reflective surface 14 being configured such that light rays coming from the set 4 of second light sources are reflected on the third reflective surface 14 after their reflection by the first reflective surface 8 and before their reflection by the second reflective surface 9.

The arrangement of this third reflective surface 14 makes it possible, with a folder effect, to take account of the maximum number of light rays originating from the set 4 of second light sources within the final resulting lighting.

According to one example, the third reflective surface 14 is at least partially formed by the second portion 5ab of the first entrance dioptric interface 5a.

By virtue of this configuration, the third reflective surface 14 and the second portion 5ab are in the same plane, thus leading the light rays coming from the second light sources to be reflected on the second reflective surface 9 after having been reflected on the third reflective surface 14. This configuration also makes it possible to simplify the lighting module.

According to one example, the second portion 5ab of the first entrance dioptric interface 5 a is inclined with respect to the first plane pl by an angle of between 0 and 10°such that the angle between said second portion 5ab and the first reflective surface 8 decreases.

This configuration makes it possible to obtain a compromise between a desired brightness distribution and a sufficient luminance. This configuration also makes it possible to obtain different lighting configurations so as to obtain lighting that is more or less toward the top of the exit dioptric interface.

According to one example, the exit dioptric interface 12 comprises an upper part 6 having an upper curvature 6a and a lower part 7 having a lower curvature 7a, the upper curvature 6a being more convex than the lower curvature 7a.

Thus, the fact that the upper curvature 6a is more convex than the lower curvature 7a makes it possible to obtain greater illumination in the upper part of the lit zone, this also enabling increased safety.

According to one example, the lighting module comprises collimators 10, each collimator 10 being associated with a separate second light source 4, each collimator 10 receiving light from said source and sending it in a collimated manner toward the second entrance dioptric interface 5b.

The positioning of a collimator associated with each light source of the set of second light sources makes it possible to obtain individually for each light source of the set of second light sources a collimated beam, that is to say a beam composed of parallel light rays. Due to their direction of intersection with the second entrance dioptric interface 5b, this configuration makes it possible to better control the path of these light rays up to the exit of the lighting module.

According to one example, the first row 1 of first light sources is configured to form a cutoff-containing beam of a low beam.

According to one example, the set 4 of second light sources is configured to form a near-field beam of a low beam.

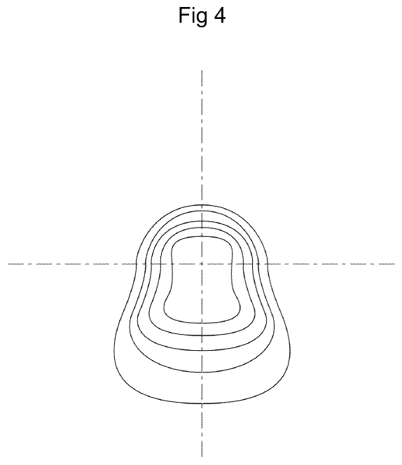

Thus, the fact that the rays coming from the first light sources of the first row 1 can pass selectively through two separate surfaces, combined with the fact that the beam resulting from these light sources can be a cutoff-containing beam of a low beam, makes it possible to create, as illustrated in FIG. 4, a sharp upper zone providing the right/left cutoff and a spread lower zone providing the required complement to solve part of the technical problem addressed by the invention. Specifically, this lower zone will be the transition with the beam coming from the set 4 of second light sources (which may be a near-field beam of a low beam) due to the reflection of this beam on the second reflective surface 9.

According to one example, the lighting module comprises a second row 2 of first light sources comprising light sources aligned in a second direction d2, the second direction d2 being parallel to the first direction d1, the second row 2 of first light sources being positioned below the first row 1 of first light sources.

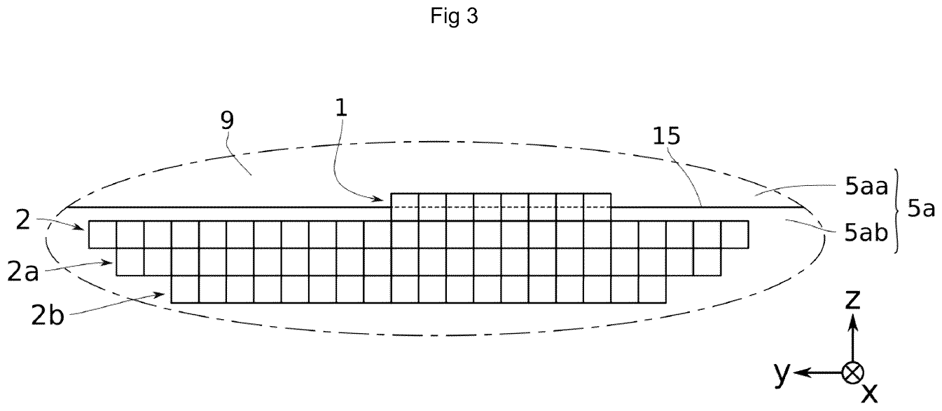

According to one example, as seen in FIG. 3, the lighting module comprises a third row 2a of first light sources comprising light sources aligned in a third direction d3 and a fourth row 2b of first light sources comprising light sources aligned in a fourth direction d4, the third direction d3 and the fourth direction d4 being parallel to the first direction d1, the third row 2a of first light sources being positioned below the second row 2 of first light sources, the fourth row 2b of first light sources being positioned below the third row 2a of first light sources.

The addition of the second row 2 of first light sources, of the third row 2a of first light sources and of the fourth row 2b of first light sources makes it possible to obtain lighting that is as extended and therefore as complete as possible.

According to one example, the second row 2 of first light sources, the third row 2a of first light sources and the fourth row 2b of first light sources are configured to form or to contribute to forming a complementary high beam.

This configuration makes it possible to obtain a lighting function that is as complete as possible.

According to one example, the light sources of the first row 1 of first light sources, of the second row 2 of first light sources, of the third row 2a of first light sources and of the fourth row 2b of first light sources are selectively activatable.

Thus, this configuration notably makes it possible to selectively configure, with the same lighting module, lighting with a cutoff that may be to the right or to the left.

According to one example, the lighting module comprises a projecting lens 11 positioned on the optical axis 13 after the primary lens 5.

Combining a primary lens with a projecting lens makes it possible to obtain the desired distribution of light in a plane perpendicular to the optical axis while still having sufficient luminous power and imaging quality.

According to one example, at least one of the entrance dioptric interface of the projecting lens 11 and the exit dioptric interface of the projecting lens 11 has on its surface reliefs of micrometric size. “Reliefs of micrometric size” is understood to mean a surface condition, notably on a dioptric interface, which has a set of protruding elements having a depth of less than 600 μm.

Thus, the positioning of these reliefs makes it possible, on the exit dioptric interface, to slightly blur the cutoff so as to obtain a regulatory gradient and, on the entrance dioptric interface, to make the beam uniform, by virtue of the presence of asperities on the surface of the dioptric interfaces, so as to create scattering of the light rays.

With respect to the features set out below, terms relating to verticality, horizontality or transversality (or even the lateral direction), or equivalents thereof, are to be understood with respect to the position in which the lighting system is intended to be fitted in a vehicle. The terms “vertical” and “horizontal” are used in the present description to denote, regarding the term “vertical”, a direction with an orientation perpendicular to the plane of the horizon (which corresponds to the height of the systems), and, regarding the term “horizontal”, a direction with an orientation parallel to the plane of the horizon. They are to be considered under the conditions of operation of the module in a vehicle. The use of these words does not mean that slight variations about the vertical and horizontal directions are excluded from the invention. For example, an inclination relative to these directions of the order of +or −10° is here considered to be a minor variation about the two preferred directions. With respect to the horizontal plane, the inclination is in principle between −5° and +4°, and it is between −6° and +7.5° laterally.

In the context of the present description, the adjectives “lower” and “upper”, and equivalents thereof (under, below, over, above), are to be considered in relation to the vertical direction, that is to say the direction perpendicular to the direction d1 and to the optical axis 9. In the same context, an upper element is situated above (but not necessarily in contact or directly in line with) a lower element, in the vertical direction.

According to one embodiment, the lighting module comprises a first row 1 of first light sources, a set 4 of second light sources, an optical axis 13 and a primary lens 5. The first row 1 of first light sources comprises light sources arranged in a straight line in the first direction d1. The first plane p1 is defined so as to contain the first direction d1 and be perpendicular to the optical axis 13.

The primary lens 5 comprises a first entrance dioptric interface 5a, a second entrance dioptric interface 5b, an exit dioptric interface 12, a first reflective surface 8 and a second reflective surface 9. The first entrance dioptric interface 5a is configured to transmit light rays coming from the first light sources of the first row 1. The exit dioptric interface 12 is configured to be passed through by light rays coming from the first light sources of the first row 1 after they have passed through the first entrance dioptric interface 5a. The second entrance dioptric interface 5b is configured to be passed through by light rays coming from the second light sources of the set 4 such that these rays are then reflected on the first reflective surface 8. The first reflective surface 8 is configured such that the light rays coming from the second light sources of the set 4 are subjected to reflection there, by total internal reflection related to the angle of the rays striking it, before being subjected to reflection on the second reflective surface 9.

The second reflective surface 9 is configured such that the light rays coming from the second light sources of the set 4 after their reflection on the first reflective surface 8 are subjected to reflection there and are directed toward the exit dioptric interface 12.

The first entrance dioptric interface 5a comprises a first portion 5aa and a second portion 5ab. The first portion 5aa and the second portion 5ab are joined at a junction line 15. The first portion 5aa and the second portion 5ab do not have the same orientation with respect to the optical axis 13.

According to a preferred embodiment, the first portion 5aa is positioned, with respect to the second portion 5ab, in the upper part of the first entrance dioptric interface 5a. The first portion 5aa is positioned between the junction line 15 (while being in contact therewith) and the exit dioptric interface 12. The first portion 5aa may be in contact with the exit dioptric interface 12.

Advantageously, the first portion 5aa is included in the second reflective surface 9.

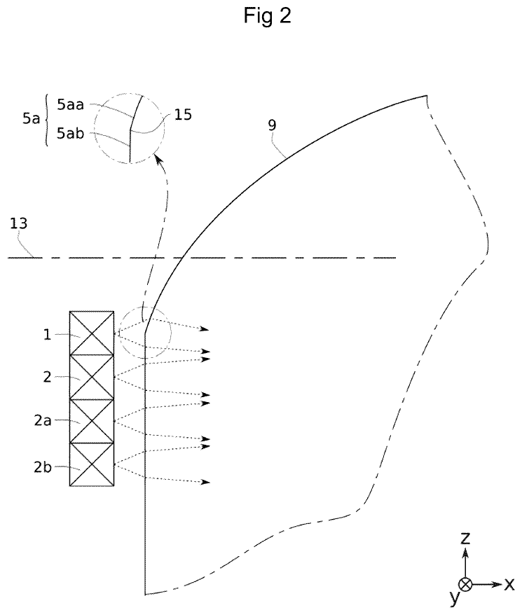

Preferably, as illustrated in FIG. 2, the second reflective surface 9 has a concave profile so as to orient light rays coming from the set of second light sources of the set 4 toward the exit dioptric interface 12. This in particular enables a convergence effect.

Advantageously, the second reflective surface 9 and the second portion 5ab of the first entrance dioptric interface 5 a forms an angle of between 115° and 155°.

Preferably, the first row 1 of first light sources is located with respect to the first entrance dioptric interface 5 a such that between 30% and 50% of the light rays coming from the first row 1 of first light sources are directed toward the first portion 5aa.

Preferably, the junction line 15 is situated with respect to the first row 1 of first light sources such that the junction line 15 divides the first row 1 of first light sources into an upper part and a lower part. The lower part is between 1% and 20% greater than the upper part.

According to an advantageous embodiment, the lighting module comprises a third reflective surface 14. The third reflective surface 14 is configured such that light rays coming from the set 4 of light sources are reflected on the third reflective surface 14 after their reflection by the first reflective surface 8 and before their reflection by the second reflective surface 9.

Preferably, the third reflective surface 14 and the second portion 5ab of the first entrance dioptric interface 5a are situated on the same surface, which is preferably planar. The third reflective surface 14 is formed by part of the second portion 5ab of the first entrance dioptric interface 5a.

Advantageously, the second portion 5ab of the first entrance dioptric interface 5a is oriented with respect to the first plane p1 so as to form an angle of between 0 and 10° with the first plane p1. Put differently, the second portion 5ab of the first entrance dioptric interface 5a is oriented (with respect to the first plane p1) such that the angle between the second portion 5ab and the first reflective surface 8 decreases.

According to a preferred embodiment, the exit dioptric interface 12 comprises an upper part 6 and a lower part 7. The upper part 6 has an upper curvature 6a. The lower part 7 has a lower curvature 7a. The upper curvature 6a is more re-entrant than the lower curvature 7a. In the case where the upper curvature 6a and the lower curvature 7a each define a circular arc, the upper curvature 6 a has a radius that is at least 30% smaller than the radius of the lower curvature 7 a.

Preferably, the lighting module comprises collimators 10. Each collimator 10 of the lighting module is associated with a separate second light source 4. Each collimator 10 then receives light from said source and sends it in a collimated manner toward the second entrance dioptric interface 5.

Preferably, the first row 1 of first light sources is configured to form a cutoff-containing beam of a low beam.

Advantageously, the set of second light sources of the set 4 is configured to form a near-field beam of a low beam.

The beam coming from the set 4 of second light sources may also be referred to as the “flat” or spread beam. It is projected widely underneath the cutoff and serves to illuminate the near field in front of the vehicle. The beam coming from the first row 1 of first light sources makes it possible to define a cutoff zone. Thus, the combination of the near-field beam and the beam coming from the first row 1 of first light sources makes it possible to at least partially define a beam of a low beam.

The beam coming from the first row 1 of first light sources is therefore configured to produce, in a low-beam mode, a cutoff-containing portion of a low beam light. The resulting angled portion is referred to as the low-beam “kink”.

Beams of the low-beam type typically have a first lateral zone (normally at the edge of the roadway) that projects at a slightly higher height than in a second lateral zone (normally at the center of the roadway), these two zones following one another laterally with the presence of a bend or kink between them.

A near-field beam of a low beam light is typically a projection that is relatively spread out laterally in front of the vehicle, predominantly or completely below the horizon line, generally seeking good distribution of the illumination over the entire lit zone.

The first row 1 of first light sources may be spaced apart from the primary lens 5 by a distance of 0.7 mm.

This distance is selected in dependence on the thermal resistance of the material of the primary lens 5, which is selected so as to minimize the distance between the light sources and the primary lens 5 as much as possible, in order to collect the maximum amount of light and therefore maximize efficiency.

The first entrance dioptric interface 5a may be separated from the exit dioptric interface 12 by a distance greater than 33 mm. This distance is taken in relation to the optical axis 13.

According to a preferred example, the lighting module comprises a second row 2 of first light sources comprising light sources arranged in a straight line in a second direction d2. The second direction d2 is parallel to the first direction d1. The second row 2 of first light sources is positioned below the first row 1 of first light sources.

Advantageously, the lighting module comprises a third row 2a of first light sources comprising light sources arranged in a straight line in the third direction d3. Advantageously, the lighting module comprises a fourth row 2b of first light sources comprising light sources arranged in a straight line in a fourth direction d4. The third direction d3 and the fourth direction d4 are parallel to the first direction d1. The third row 2a of first light sources is positioned below the second row 2 of first light sources. The fourth row 2b of first light sources is positioned below the third row 2a of first light sources.

The first row 1 of first light sources, the second row 2 of first light sources, the third row 2a of first light sources and the fourth row 2b of first light sources may be fastened to a first support. The set 4 of second light sources may be fastened to a second support. These supports may be in the form of printed circuit boards (PCB). The rows may be fastened to these supports by adhesive bonding or by another type of fastening, for example using fasteners.

Preferably, the second row 2 of first light sources, the third row 2a of first light sources and the fourth row 2b of first light sources are configured to form or to contribute to forming a complementary high beam. The light sources of rows 2, 2a and 2b enter the primary lens through the second portion of the first entrance dioptric interface.

The invention may contribute to a high-beam function the purpose of which is to illuminate a large extent of the scene in front of the vehicle, but also to a distance away that is substantial, and typically about two hundred meters. This light beam, due to its lighting function, is mainly located above the horizon line. It may for example have a slightly upward sloping lighting optical axis. In particular, it may be used to generate a “complementary beam” lighting function that forms a portion of a high beam complementary to the one produced by a near-field beam, the complementary high beam seeking entirely, or at least mainly, to light above the horizon line, whereas the near-field beam (which may have the specific features of a low beam) seeks to light entirely, or at least mainly, below the horizon line. The complementary high-beam portion may therefore be a main part of the overall “high” beam and be associated with another beam participating in the low beam.

The module may also be used for other lighting functions via or apart from those described above, in relation to adaptive beams. This makes it possible to produce a lighting matrix to selectively illuminate parts of the space in front of the vehicle.

Advantageously, all or only some of the light sources of the first row 1 of first light sources, of the second row 2 of first light sources, of the third row 2a of first light sources and of the fourth row 2b of first light sources are selectively activatable, thus creating a pixelated light source. This configuration makes it possible to control the value of the brightness according to the zone in question. The acronym ADB (for adaptive driving beam) is used for this type of function.

Specifically, selective activation of the light sources makes it possible to obtain varied light beam configurations making it possible to adapt to various situations. The zones that should be lit thus are, and those in which the brightness should be reduced due to regulatory constraints also will be.

This discretization of the light is also referred to as a segmented beam. A beam the projection of which forms an image composed of beam segments, each segment being able to be lit up independently, is thus referred to as a segmented beam.

Thus, all the emissive elements are not necessarily active, i.e. emit light, simultaneously. This function allows the shape of the generated beam to be modulated. If a light source is not activated, its image, as projected by the optical module, will be null. It then forms a lighting void in the resulting overall beam. This void is interrupted only by source-coupling effects and the effects of stray light from the optics.

The system according to the invention may comprise a unit for driving the activation of each of the sources that is configured to produce at least one dark zone forming a tunnel in a projected beam by deactivating a group of adjacent sources, the driving unit being configured to determine the number of sources of the group corresponding to the dark zone depending on the widthwise dimension of the sources.

The driving unit may comprise a computer program product, preferably stored in a non-transitory memory, the computer program product comprising instructions that, when executed by a processor, determine the sources to be activated, in particular to obtain at least one dark zone (in which the sources are not activated) of defined area, taking into account the variable surface area of the images of the elements.

The light sources of the rows 1, 2, 2a and 2b of light sources may each be made up of 24 light sources. There may be 8 light sources in the set 4 of second light sources.

The light sources of the set 4 of second light sources may be aligned in a direction parallel to the direction d1.

The light sources of the overall device may be light-emitting diodes, also commonly called LEDs.

Advantageously, the LEDs of the overall lighting module have an emissive surface area of 0.5 mm2 or of 1mm2 . The LEDs may have a height of 0.74 mm and a width of 1 mm. The size of the LEDs is directly linked to the volume of the desired beam. Moreover, in order to have a large beam volume, it is also possible to add rows of LEDs.

Two consecutive light sources of the first row 1 of first light sources, of the second row 2 of first light sources, of the third row 2a of first light sources and of the fourth row 2b of first light sources may be at a distance of 0.025 mm.

The rows 1, 2, 2a and 2b of light sources may be spaced apart from one another by a distance of 1.025 mm.

The rows 1, 2, 2a and 2b of light sources may be spaced apart from the set 4 of second light sources by a distance of between 10 mm and 30 mm.

The set 4 of second light sources may be positioned at a distance of 1 mm from the first reflective surface 8.

According to a preferred embodiment, the lighting module comprises a projecting lens 11 positioned on the optical axis 13 after the primary lens 5.

The distance between the entrance dioptric interface and the exit dioptric interface of the projecting lens 11 may be 32 mm.

The distance between the primary lens 5 and the projecting lens 11 may be 6.8 mm.

Preferably, the primary lens 5 and the projecting lens 11 are made of PMMA (polymethyl methacrylate), silicone, glass or PC (polycarbonate), which enables better thermal resistance than PPMA. The system comprising the primary lens 5 and the projecting lens 11 may have a focal distance of 42.5 mm. The field of view of the beam coming from the second light sources and exiting the projecting lens 11 may be 35°.

Advantageously, the primary lens 5 and the projecting lens 11 have a size of 30 by 60 mm (taking account of the fastening zones).

According to an advantageous embodiment, the optical axis 13 and the first direction d1 are orthogonal.

According to a preferred example, at least one of the entrance dioptric interface of the projecting lens 11 and the exit dioptric interface of the projecting lens 11 has on its surface a protruding microstructure. This microstructure may protrude over a depth of less than 50 μm for the exit dioptric interface and over a depth of less than 600 μm for the entrance dioptric interface. This microstructure may have concentric patterns. The patterns may be ridges or studs.

Several lighting modules according to the invention may be arranged in a housing closed by an outer lens so as to obtain one or more lighting and/or signaling beams at the exit of the headlamp. A headlamp may also be complex and comprise a plurality of modules that may, furthermore, optionally share components.

The invention is not limited to the embodiments described above and extends to all the embodiments covered by the invention.

### List of References

1. first row of first light sources
2. second row of first light sources
2a. third row of first light sources
2b. fourth row of first light sources
4. set of second light sources
5. primary lens
5a. first entrance dioptric interface
5aa. first portion
5ab. second portion
5b. second entrance dioptric interface
6. upper part
6a. upper curvature
7. lower part
7a. lower curvature
8. first reflective surface
9. second reflective surface
10. collimators
11. projecting lens
12. exit dioptric interface
13. optical axis
14. third reflective surface
15. junction line
d1. first direction
d2. second direction
d3. third direction
d4. fourth direction
p1. first plane

What is claimed is:

1. A lighting module comprising:
a first row of first light sources including light sources aligned in a first direction set of second light sources,
an optical axis, a first plane being defined so as to contain the first direction and be perpendicular to the optical axis
a primary lens including a first entrance dioptric interface and an exit dioptric interface, the first entrance dioptric interface being configured to receive light rays coming from the first light sources of the first row, the exit dioptric interface being configured to transmit light rays coming from the first light sources of the first row and received by the first entrance dioptric interface,
the primary lens also includes a second entrance dioptric interface, a first reflective surface and a second reflective surface, the second entrance dioptric interface being configured to receive light rays coming from the second light sources of the set and to transmit them the light rays to the first reflective surface, the first reflective surface being configured to reflect light rays coming from the second light sources of the set toward the second reflective surface,
wherein the second reflective surface is configured to reflect the light rays coming from the second light sources of the set toward the exit dioptric interface after their the light rays reflection on the first reflective surface, and
in that the first entrance dioptric interface includes a first portion and a second portion joined by a junction line the first portion and the second portion being inclined differently with respect to the optical axis.

2. The lighting module as claimed in claim 1, wherein the first portion is positioned at the upper end of the first entrance dioptric interface the first portion extending from the junction line toward the exit dioptric interface.

3. The lighting module as claimed in claim 1, wherein the first portion forms part of the second reflective surface.

4. The lighting module as claimed claim 1, wherein the second reflective surface forms an angle of between 115° and 155° with the second portion of the first entrance dioptric interface

5. The lighting module as claimed in claim 1, wherein the first row of first light sources is positioned in a direction transverse to the first direction such that between 30% and 50% of the light rays coming from the first row of first light sources are refracted by the first portion

6. The lighting module as claimed in claim 1, wherein the junction line projects on the first row of first light sources in a direction parallel to the optical axis so as to divide the first row of first light sources into an upper part and a lower part, the lower part being between 1% and 20% greater than the upper part.

7. The lighting module as claimed in claim 1, wherein the second portion of the first entrance dioptric interface is inclined with respect to the first plane by an angle of between 0 and 10° such that the angle between said the second portion and the first reflective surface decreases.

8. The lighting module as claimed claim 1, further comprising collimators, each collimator being associated with a separate second light source, each collimator receiving light from said the source and sending the light in a collimated manner toward the second entrance dioptric interface

9. The lighting module as claimed claim 1, wherein the first row of first light sources is configured to form a cutoff-containing beam of a low beam.

10. The lighting module as claimed in claim 1, wherein the set of second light sources is configured to form a near-field beam of a low beam.

11. The lighting module as claimed in claim 1, further comprising a second row of first light sources comprising light sources aligned in a second direction, the second direction being parallel to the first direction the second row of first light sources being positioned below the first of first light sources.

12. The lighting module as claimed in claim 11, further comprising a third row of first light sources comprising light sources aligned in a third direction and a fourth row of first light sources comprising light sources aligned in a fourth direction, the third direction and the fourth direction being parallel to the first direction the third row of first light sources being positioned below the second row of first light sources, the fourth row of first light sources being positioned below the third row of first light sources.

13. The lighting module as claimed in claim 12, wherein the second row of first light sources, the third row of first light sources and the fourth row of first light sources are configured to form or to contribute to forming a complementary high beam.

14. The lighting module as claimed in claim 1, further comprising a projecting lens positioned on the optical axis after the primary lens.
